(19) United States
(12) Patent Application Publication
(10) Pub. No.: US 2026/0319165 A1
(43) Pub. Date: Oct. 15, 2026

(54) WAVEGUIDE MODULE, DISPLAY DEVICE AND MANUFACTURING METHOD FOR WAVEGUIDE MODULE

(71) Applicant: Beijing Zitiao Network Technology Co., Ltd., Haidian District, Beijing (CN)

(72) Inventors: Wei TAN, Beijing (CN); Hao TANG, Beijing (CN); Wen XIONG, Beijing (CN)

(21) Appl. No.: 19/476,327

(22) PCT Filed: Oct. 28, 2024
(86) PCT No.: PCT/CN2024/127805

§ 371 Date: Oct. 17, 2025

(30) Foreign Application Priority Data
Nov. 17, 2023 (CN) 202311541235.7

(51) Int. Cl. F21V 8/00; G02B 27/01

(52) U.S. Cl. CPC G02B 6/0093; G02B 6/0065; G02B 27/0176

(57) ABSTRACT

A waveguide module, a display device and a manufacturing method for the waveguide module. The waveguide module comprises: a waveguide structure; and a first cover plate located on at least one of opposite sides of the waveguide structure, wherein the first cover plate comprises a first protective layer and a second protective layer located between the first protective layer and the waveguide structure; and a rigidity of the second protective layer is greater than a rigidity of the first protective layer.

### CROSS-REFERENCE TO RELATED APPLICATIONS

The present application is based on and claims priority to Chinese Application No. 202311541235.7, filed on Nov. 17, 2023, the disclosure of which is incorporated herein by reference in its entirety.

### TECHNICAL FIELD

The present application relates to the technical field of display, and particularly to a waveguide module, a display device, and a method for manufacturing a waveguide module.

### BACKGROUND

In order to reduce the overall weight and thickness of the waveguide module, a cover plate of the waveguide module is made of a low-density material (such as resin), and the thickness of the cover plate is set to be relatively thin. However, the rigidity of such a cover plate is insufficient, which causes the waveguide module to be prone to deformation when subjected to an external force, and the cover plate to be prone to delamination when subjected to a high-temperature shock, resulting in poor reliability of the waveguide module.

### SUMMARY

The present application provides waveguide module, a display device and a method for manufacturing a waveguide module.

In a first aspect, the present application provides a waveguide module, including: a waveguide structure; and

a first cover plate located on at least one of opposite sides of the waveguide structure, where the first cover plate includes a first protective layer and a second protective layer located between the first protective layer and the waveguide structure; and a rigidity of the second protective layer is greater than a rigidity of the first protective layer.

According to an embodiment of the present application, a density of the second protective layer is greater than a density of the first protective layer, and a thickness of the second protective layer is less than a thickness of the first protective layer to reduce the weight and thickness of the cover plate, thereby reducing the weight and thickness of the waveguide module.

According to an embodiment of the present application, the first cover plate further includes an adhesive layer; and

the adhesive layer is located between the first protective layer and the second protective layer.

According to an embodiment of the present application, the first protective layer includes a resin layer, and the second protective layer includes an ultra-thin glass layer.

According to an embodiment of the present application, the thickness of the first protective layer is between 0.3 mm and 1 mm, and the thickness of the second protective layer is between 0.05 mm and 0.3 mm.

According to an embodiment of the present application, the waveguide module further includes a gluing structure; and

the gluing structure is located between the waveguide structure and the second protective layer.

According to an embodiment of the present application, the first cover plate is located on one side of the waveguide structure, and the waveguide module further includes a second cover plate; and

the second cover plate is located on a side of the waveguide structure facing away from the first cover plate.

According to an embodiment of the present application, a material of the second cover plate includes at least one of resin, sapphire, or tempered glass.

According to an embodiment of the present application, the waveguide structure includes at least one waveguide layer and at least one grating layer;

the at least one waveguide layer and the at least one grating layer are alternately stacked; and the opposite sides of the waveguide structure are opposite sides in a stacking direction of the waveguide layer and the grating layer.

According to an embodiment of the present application, the waveguide module further includes an edge-sealing structure; and

the edge-sealing structure is located on side surfaces of the waveguide structure and the first cover plate.

In a second aspect, the present application provides a display device including the waveguide module as described above.

In a third aspect, the present application provides a method for manufacturing a waveguide module, the method including:

forming a first cover plate, where the first cover plate includes a first protective layer and a second protective layer located on one side of the first protective layer, and a rigidity of the second protective layer is greater than a rigidity of the first protective layer; forming a waveguide structure; and
laminating the first cover plate to at least one of opposite sides of the waveguide structure, where the second protective layer is located between the first protective layer and the waveguide structure.

### BRIEF DESCRIPTION OF THE DRAWINGS

The above and/or additional aspects and advantages of the present application will become apparent and easy to understand from the following description of embodiments with reference to the accompanying drawings, in which:

FIG. 1 is a schematic flowchart of a method for manufacturing a waveguide module according to one or more embodiments of the present application;

FIG. 2 is a first schematic structural diagram of a method for manufacturing a waveguide module according to one or more embodiments of the present application;

FIG. 3 is a second schematic structural diagram of the method for manufacturing a waveguide module according to one or more embodiments of the present application;

FIG. 4 is a third schematic structural diagram of the method for manufacturing a waveguide module according to one or more embodiments of the present application;

FIG. 5 is a fourth schematic structural diagram of the method for manufacturing a waveguide module according to one or more embodiments of the present application;

FIG. 6 is a fifth schematic structural diagram of the method for manufacturing a waveguide module according to one or more embodiments of the present application;

FIG. 7 is a first schematic structural diagram of a waveguide module according to one or more embodiments of the present application; and

FIG. 8 is a second schematic structural diagram of the waveguide module according to one or more embodiments of the present application.

### DETAILED DESCRIPTION

Embodiments of the present application will be described in detail below. Examples of the embodiments are shown in the accompanying drawings, and throughout the accompanying drawings, the same or similar reference signs refer to the same or similar elements or elements having the same or similar functions. The embodiments described below with reference to the accompanying drawings are exemplary and are merely intended to be illustrative of the present application, but should not be construed as limiting the present application.

The present application is intended to solve at least one of the technical problems existing in the related art. To this end, the present application provides a waveguide module, a display device, and a method for manufacturing a waveguide module, which can increase the rigidity of cover plates, thereby enhancing the reliability of the waveguide module.

In the waveguide module according to the present application, the second protective layer is disposed on one side of the first protective layer, and the rigidity of the second protective layer is greater than the rigidity of the first protective layer, thereby increasing the rigidity of the cover plate, reducing the risk of deformation of the waveguide module when subjected to an external force, and reducing the risk of delamination of the cover plate when the waveguide module is subjected to a high-temperature shock, thus enhancing the reliability of the waveguide module.

In the display device according to the present application, the second protective layer is disposed on one side of the first protective layer, and the rigidity of the second protective layer is greater than the rigidity of the first protective layer, thereby increasing the rigidity of the cover plate, reducing the risk of deformation of the waveguide module when subjected to an external force, and reducing the risk of delamination of the cover plate when the waveguide module is subjected to a high-temperature shock, thus enhancing the reliability of the waveguide module and further improving the reliability of the display device.

In the method for manufacturing a waveguide module according to the present application, the second protective layer is disposed on one side of the first protective layer, and the rigidity of the second protective layer is greater than the rigidity of the first protective layer, thereby increasing the rigidity of the cover plate, reducing the risk of deformation of the waveguide module when subjected to an external force, and reducing the risk of delamination of the cover plate when the waveguide module is subjected to a high-temperature shock, thus enhancing the reliability of the waveguide module.

One or more of the technical solutions in the embodiments of the present application have at least one of the following technical effects.

The second protective layer is disposed on one side of the first protective layer, and the rigidity of the second protective layer is greater than the rigidity of the first protective layer, thereby increasing the rigidity of the cover plate, reducing the risk of deformation of the waveguide module when subjected to an external force, and reducing the risk of delamination of the cover plate when the waveguide module is subjected to a high-temperature shock, thus enhancing the reliability of the waveguide module.

Further, the density of the second protective layer is greater than the density of the first protective layer, and the thickness of the second protective layer is less than the thickness of the first protective layer to reduce the weight and thickness of the cover plate, thereby reducing the weight and thickness of the waveguide module.

Additional aspects and advantages of the present application will be set forth in part in the following description, and in part will be apparent from the following description, or may be learned by practice of the present application.

The waveguide module, the display device, and the method for manufacturing a waveguide module according to the embodiments of the present application will be described below with reference to the accompanying drawings.

Augmented Reality (AR) technology is a technology that combines virtual information with the real world. The optical display technologies thereof mainly include array waveguide schemes, volume holography schemes, birdbath schemes, free-form surface schemes, etc. Diffractive waveguide schemes based on surface relief have become one of the mainstream optical display schemes thanks to their advantages such as compact size, light weight, high transmittance, and easy adaptability to the required forms of display devices. The waveguide module is an essential component in the diffractive waveguide schemes.

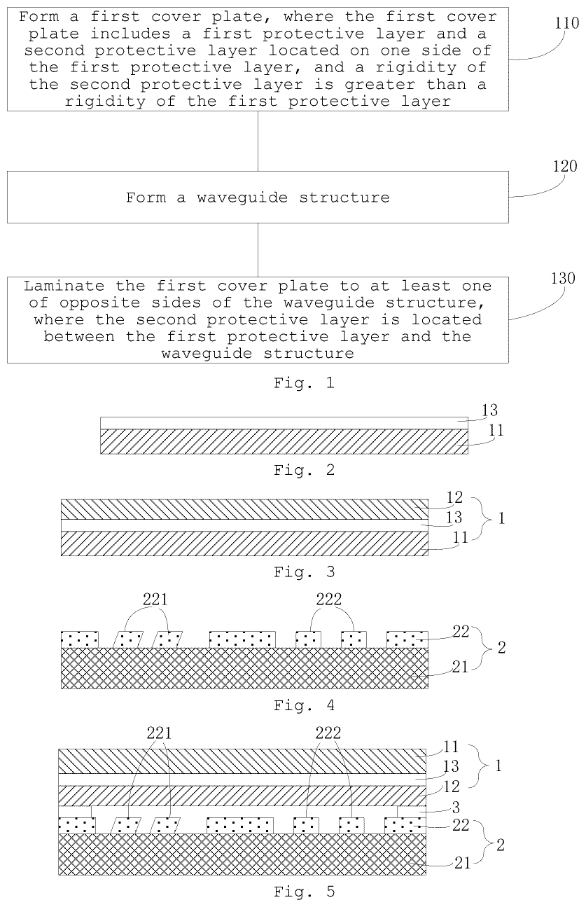

FIG. 1 is a schematic flowchart of a method for manufacturing a waveguide module according to the embodiments of the present application.

As shown in FIG. 1, the method for manufacturing a waveguide module provided in the embodiment of the present application includes steps 110 to 130.

At step 110, a first cover plate is formed. The first cover plate includes a first protective layer and a second protective layer located on one side of the first protective layer; and a rigidity of the second protective layer is greater than a rigidity of the first protective layer.

As shown in FIG. 2 and FIG. 3, in this embodiment, the first protective layer 11 may be a film layer having a relatively low density, i.e., the density of the first protective layer 11 is less than a target density. With the same size, the first protective layer 11 is lighter in weight, thereby reducing the weight of the first cover plate 1. The first protective layer 11 may include a resin layer, etc. The thickness of the first protective layer 11 may be relatively small, i.e., the thickness of the first protective layer 11 is smaller than a target thickness, thereby reducing the thickness of the first cover plate 1. The thickness of the first protective layer 11 may be between 0.3 mm and 1 mm.

The first protective layer 11 is lighter in weight and thinner in thickness, resulting in the rigidity of the first protective layer 11 being insufficient. When only the first protective layer 11 is provided in the first cover plate 1, the rigidity of the first cover plate 1 is insufficient. In this embodiment, the second protective layer 12 is disposed on one side of the first protective layer 11, and the rigidity of the second protective layer 12 is relatively high, i.e., the rigidity of the second protective layer 12 is greater than the rigidity of the first protective layer 11, thereby increasing the rigidity of the first cover plate 1.

In some embodiments, the density of the second protective layer 12 is greater than the density of the first protective layer 11, and the thickness of the second protective layer 12 is less than the thickness of the first protective layer 11.

Due to the relatively great rigidity of the second protective layer 12, the density of the second protective layer 12 is relatively high, i.e., the density of the second protective layer 12 is greater than the density of the first protective layer 11. Due to the relatively high density of the second protective layer 12, with the same size, the weight of the second protective layer 12 is larger. In order to achieve a reduction in the weight and thickness of the first cover plate 1 even when the second protective layer 12 is provided, the second protective layer 12 may be configured to have an ultra-thin thickness, i.e., the thickness of the second protective layer 12 is less than the thickness of the first protective layer 11. The second protective layer 12 may include an ultra-thin glass (UTG) layer, etc. The thickness of the second protective layer 12 may be between 0.05 mm and 0.3 mm.

The first cover plate 1 in this embodiment includes a first protective layer 11 and a second protective layer 12, so as to reduce the weight and thickness of the first cover plate 1 while increasing the rigidity of the first cover plate 1, thereby reducing the weight and thickness of the waveguide module.

In some embodiments, the first cover plate 1 further includes an adhesive layer 13 between the first protective layer 11 and the second protective layer 12. The adhesive layer 13 is configured to laminate the first protective layer 11 to the second protective layer 12.

A material of the adhesive layer 13 may include an optically clear adhesive (OCA), a liquid optical clear adhesive (LOCA)/an optical clear resin (OCR), etc. A thickness of the adhesive layer 13 may be between 0.1 micrometers and 0.5 micrometers.

In some embodiments, forming the first cover plate in step 110 includes:

laminating the first protective layer to the second protective layer via the adhesive layer to obtain the first cover plate.

Firstly, surfaces of the first protective layer 11 and the second protective layer 12 are cleaned. Secondly, as shown in FIG. 2, one side of the first protective layer 11 is laminated to one side of the adhesive layer 13. As shown in FIG. 3, one side of the second protective layer 12 is laminated to a side of the adhesive layer 13 facing away from the first protective layer 11. It should be noted that one side of the second protective layer 12 may be laminated to one side of the adhesive layer 13 first, and then one side of the first protective layer 11 may be laminated to a side of the adhesive layer 13 facing away from the second protective layer 12. The lamination sequence of the first protective layer 11 and the second protective layer 12 with the adhesive layer 13 is not specifically limited.

The lamination process may be an OCA lamination process, an LOCA lamination process, or another lamination process, which is not specifically limited herein.

The first cover plate 1 is obtained by laminating the first protective layer 11 to the second protective layer 12 via the adhesive layer 13. The adhesive layer 13 may allow the first protective layer 11 and the second protective layer 12 to be laminated over the entire surfaces, i.e., the adhesive layer 13 may cover the entire surface of the first protective layer 11 on the side close to the second protective layer 12, and cover the entire surface of the second protective layer 12 on the side close to the first protective layer 11.

Laminating the first protective layer 11 to the second protective layer 12 over the entire surfaces via the adhesive layer 13 can improve the adhesion strength between the first protective layer 11 and the second protective layer 12, and reduce the risk of delamination between the first protective layer 11 and the second protective layer 12 when the waveguide module is subjected to a high-temperature shock.

At step 120, a waveguide structure is formed.

As shown in FIG. 4, the waveguide structure 2 may include at least one waveguide layer 21 and at least one grating layer 22, and the at least one waveguide layer 21 and the at least one grating layer 22 are alternately stacked. When the waveguide structure 2 includes one waveguide layer 21 and one grating layer 22, the grating layer 22 is located on one side of the waveguide layer 21. When the waveguide structure 2 includes a plurality of waveguide layers 21 and a plurality of grating layers 22, the number of waveguide layers 21 is the same as the number of grating layers 22, and the plurality of waveguide layers 21 and the plurality of grating layers 22 are alternately stacked, i.e., one grating layer 22 is disposed between any two adjacent waveguide layers 21, and one waveguide layer 21 is disposed between any two adjacent grating layers 22.

Taking the waveguide structure 2 including one waveguide layer 21 and one grating layer 22 as an example, during the formation of the waveguide structure 2, an initial grating layer is first formed on one side of the waveguide layer 21. The initial grating layer may cover the surface on one side of the waveguide layer 21. The initial grating layer is then processed to form the grating layer 22 on one side of the waveguide layer 21. As shown in FIG. 4, the waveguide layer 21 and the grating layer 22 form the waveguide structure 2. The process for processing the initial grating layer may be a nanoimprint lithography process, an etching process, or other processes, which are not specifically limited herein.

The material of the waveguide layer 21 is a high-refractive-index material, such as high-refractive-index glass or resin. A refractive index of the waveguide layer 21 may be between 1.5 and 2.1. The material of the grating layer 22 may include titanium oxide, silicon nitride, zirconium oxide, hafnium oxide, or the like.

For a waveguide structure of a one-dimensional architecture, as shown in FIG. 4, the grating layer 22 may include an in-coupling grating 221 and a turning and out-coupling grating 222. For a waveguide structure of a two-dimensional architecture, the grating layer includes an in-coupling grating and an out-coupling grating.

The basic principle of the waveguide structure 2 is that the in-coupling grating 221 couples light from an external optical engine into the waveguide layer 21, where the light propagates forward within the waveguide layer 21 via total internal reflection, and is then coupled out via the turning and out-coupling grating 222 (or the out-coupling grating) after pupil expansion, so as to integrate external ambient light with virtual information before reaching human eyes, thereby achieving an augmented display effect.

At step 130, the first cover plate is laminated to at least one of opposite sides of the waveguide structure, where the second protective layer is located between the first protective layer and the waveguide structure.

The first cover plate 1 may be laminated to the opposite sides of the waveguide structure 2, or may be laminated to one of the opposite sides of the waveguide structure 2. The opposite sides of the waveguide structure 2 refer to opposite sides in a stacking direction of the waveguide layer 21 and the grating layer 22 of the waveguide structure 2. The first cover plate 1 is configured to protect the waveguide structure 2.

In some embodiments, as shown in FIG. 5, the first cover plate 1 is laminated to the waveguide structure 2 via the gluing structure 3. The second protective layer 12 of the first cover plate 1 is located between the first protective layer 11 and the waveguide structure 2, i.e., the second protective layer 12 of the first cover plate 1 is laminated to the waveguide structure 2 via the gluing structure 3. It should be noted that the gluing structure 3 is located at an edge of the waveguide structure 2, i.e., the gluing structure 3 is located on a side of the in-coupling grating 221 of the grating layer 22 facing away from the turning and out-coupling grating 222 (or out-coupling grating) and on a side of the turning and out-coupling grating 222 (or out-coupling grating) facing away from the in-coupling grating 221 to prevent the gluing structure 3 from affecting the light transmission in the waveguide structure 2.

The gluing structure 3 may be a frame adhesive, and the material of the gluing structure 3 may include OCA, OCR, etc. The thickness of the gluing structure 3 may be between 30 micrometers and 100 micrometers.

Due to the high density and high rigidity of the second protective layer 12, the adhesion strength between the second protective layer 12 and the gluing structure 3 is greater than the adhesion strength between the first protective layer 11 and the gluing structure 3, thereby reducing the risk of delamination of the first cover plate 1 when the waveguide module is subjected to a high-temperature shock.

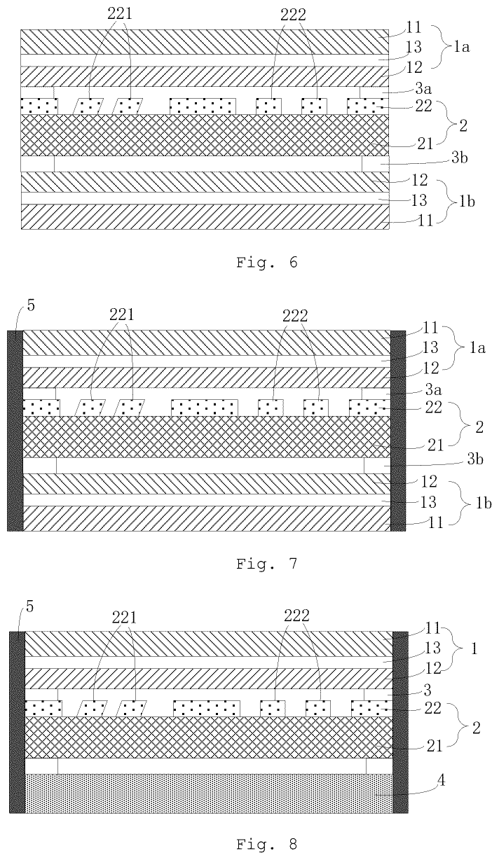

In some embodiments, first cover plates 1 are laminated to the opposite sides of the waveguide structure 2, i.e., two first cover plates (i.e., a first cover plate 1a and a second cover plate 1b) may be formed in step 110. With reference to FIG. 6, first, a second protective layer 12 of the first cover plate 1a is laminated to one side (e.g., the side of the grating layer 22 facing away from the waveguide layer 21) of the waveguide structure 2 via a gluing structure 3a. A second protective layer 12 of the first cover plate 1b is then laminated to the other side (e.g., the side of the waveguide layer 21 facing away from the grating layer 22) of the waveguide structure 2 via a gluing structure 3b.

In some embodiments, with reference to FIG. 7 and FIG. 8, the method for manufacturing a waveguide module further includes: forming an edge-sealing structure 5 on side surfaces of the waveguide structure 2 and the first cover plate 1. The edge-sealing structure 5 is configured to absorb light. The material of the edge-sealing structure 5 may include ink, UV resin, etc. The thickness of the edge-sealing structure 5 may be between 0.3 mm and 2 mm.

As shown in FIG. 7, after the first cover plate 1a and the first cover plate 1b are respectively laminated to the opposite sides of the waveguide structure 2, an edge-sealing process is employed to form the edge-sealing structure 5 on the side surfaces of the first cover plate 1a, the waveguide structure 2 and the first cover plate 1b.

In some embodiments, the first cover plate 1 is laminated to one side of the waveguide structure 2. The method for manufacturing a waveguide module further includes: laminating a second cover plate 4 to a side of the waveguide structure 2 facing away from the first cover plate 1. The second cover plate 4 is configured to protect the waveguide structure 2. The material of the second cover plate 4 may include at least one of resin, sapphire, or tempered glass. The thickness of the second cover plate 4 may be between 1 mm and 2 mm.

As shown in FIG. 8, the second protective layer 12 of the first cover plate 1 is laminated to one side (e.g., the side of the grating layer 22 facing away from the waveguide layer 21) of the waveguide structure 2 via the gluing structure 3a. The second cover plate 4 is laminated to the other side (e.g., the side of the waveguide layer 21 facing away from the grating layer 22) of the waveguide structure 2 via the gluing structure 3b.

In some embodiments, the method for manufacturing a waveguide module further includes: forming an edge-sealing structure 5 on side surfaces of the waveguide structure 2, the first cover plate 1 and the second cover plate 4.

As shown in FIG. 8, after the first cover plate 1 and the second cover plate 4 are respectively laminated to the opposite sides of the waveguide structure 2, an edge-sealing process is employed to form the edge-sealing structure 5 on the side surfaces of the first cover plate 1, the waveguide structure 2 and the second cover plate 4.

In the related art, the cover plate of the waveguide module is made of glass, which has a high rigidity but also has a high density, resulting in a relatively high weight of the waveguide module. To reduce the weight of the waveguide module, in the related art, the cover plate of the waveguide module is replaced with a material having a lower density, such as the material of the first protective layer 11, and the thickness of the cover plate is reduced, resulting in insufficient rigidity of the cover plate. When the waveguide module is subjected to an external force, the cover plate tends to deform, which may in turn cause deformation of a grating. In addition, when the waveguide module is subjected to a high-temperature shock, the cover plate is prone to delamination, which may result in poor reliability of the waveguide module.

However, the first cover plate 1 in the embodiments of the present application includes a first protective layer 11 and a second protective layer 12. The first protective layer 11 has a relatively low density and a relatively thin thickness to reduce the weight and thickness of the first cover plate 1. The second protective layer 12 has a relatively high rigidity to increase the rigidity of the first cover plate 1. The configuration of the ultra-thin second protective layer 12 does not significantly affect the weight and thickness of the first cover plate 1. As a result, the rigidity of the first cover plate 1 is increased while the weight and thickness of the waveguide module are reduced, thereby reducing the risk of deformation of the waveguide module when subjected to an external force and the risk of delamination of the cover plate when the waveguide module is subjected to a high-temperature shock, and ultimately enhancing the reliability of the waveguide module.

Accordingly, the embodiments of the present application also provide a waveguide module.

As shown in FIG. 7 and FIG. 8, the waveguide module according to the embodiments of the present application includes a first cover plate 1 and a waveguide structure 2. The first cover plate 1 is located on at least one of opposite sides of the waveguide structure 2, and the opposite sides of the waveguide structure 2 refer to a light-incident/light-emitting side (the light-incident side and the light-emitting side of the waveguide structure 2 are located on the same side) and a backlight side of the waveguide structure 2. That is, the first cover plate 1 may be located on the light-incident/light-emitting side of the waveguide structure 2, on the backlight side of the waveguide structure 2, or on both the light-incident/light-emitting side and the backlight side of the waveguide structure 2. The first cover plate 1 is configured to protect the waveguide structure 2.

The first cover plate 1 includes a first protective layer 11 and a second protective layer 12. The second protective layer 12 is located between the first protective layer 11 and the waveguide structure 2. The rigidity of the second protective layer 12 is greater than the rigidity of the first protective layer 11.

The first protective layer 11 in this embodiment may be a film layer having a relatively low density, i.e., the density of the first protective layer 11 is less than a target density. With the same size, the first protective layer 11 is lighter in weight, thereby reducing the weight of the first cover plate 1. The first protective layer 11 may include a resin layer, etc. The thickness of the first protective layer 11 may be relatively small, i.e., the thickness of the first protective layer 11 is smaller than a target thickness, thereby reducing the thickness of the first cover plate 1. The thickness of the first protective layer 11 may be between 0.3 mm and 1 mm.

The first protective layer 11 is lighter in weight and thinner in thickness, resulting in the rigidity of the first protective layer 11 being insufficient. When only the first protective layer 11 is provided in the first cover plate 1, the rigidity of the first cover plate 1 is insufficient. In this embodiment, the second protective layer 12 is disposed on one side of the first protective layer 11. The second protective layer 12 has a relatively high rigidity, i.e., the rigidity of the second protective layer 12 is greater than the rigidity of the first protective layer 11, thereby increasing the rigidity of the first cover plate 1, reducing the risk of deformation of the waveguide module when subjected to an external force, and reducing the risk of delamination of the cover plate when the waveguide module is subjected to a high-temperature shock, thus enhancing the reliability of the waveguide module.

In some embodiments, the density of the second protective layer 12 is greater than the density of the first protective layer 11, and the thickness of the second protective layer 12 is less than the thickness of the first protective layer 11.

Due to the relatively great rigidity of the second protective layer 12, the density of the second protective layer 12 is relatively high, i.e., the density of the second protective layer 12 is greater than the density of the first protective layer 11. Due to the relatively high density of the second protective layer 12, with the same size, the weight of the second protective layer 12 is larger. In order to achieve a reduction in the weight and thickness of the first cover plate 1 even when the second protective layer 12 is provided, the second protective layer 12 is configured to have an ultra-thin thickness, i.e., the thickness of the second protective layer 12 is less than the thickness of the first protective layer 11, so as to increase the rigidity of the first cover plate 1 while reducing the weight and thickness of the first cover plate 1. The second protective layer 12 may include an ultra-thin glass layer, etc. The thickness of the second protective layer 12 may be between 0.05 mm and 0.3 mm.

In the embodiments of the present application, the thinner second protective layer is disposed on one side of the first protective layer with a lower density, thereby reducing the weight and thickness of the cover plate and consequently reducing the weight and thickness of the waveguide module. Moreover, since the rigidity of the second protective layer is greater than the rigidity of the first protective layer, the rigidity of the cover plate is increased, reducing the risk of deformation of the waveguide module when subjected to an external force and the risk of delamination of the cover plate when the waveguide module is subjected to a high-temperature shock, thereby enhancing the reliability of the waveguide module.

In some embodiments, the first cover plate 1 further includes an adhesive layer 13. The adhesive layer 13 is located between the first protective layer 11 and the second protective layer 12. The adhesive layer 13 is configured to laminate the first protective layer 11 to the second protective layer 12.

It should be noted that the adhesive layer 13 may allow the first protective layer 11 and the second protective layer 12 to be laminated over the entire surfaces, i.e., the adhesive layer 13 may cover the entire surface of the first protective layer 11 on the side close to the second protective layer 12, and cover the entire surface of the second protective layer 12 on the side close to the first protective layer 11.

Laminating the first protective layer 11 to the second protective layer 12 over the entire surfaces via the adhesive layer 13 can improve the adhesion strength between the first protective layer 11 and the second protective layer 12, and reduce the risk of delamination between the first protective layer 11 and the second protective layer 12 when the waveguide module is subjected to a high-temperature shock.

The material of the adhesive layer 13 may include OCA, LOCA/OCR, etc. The thickness of the adhesive layer 13 may be between 0.1 micrometers and 0.5 micrometers.

In some embodiments, the waveguide structure 2 includes at least one waveguide layer 21 and at least one grating layer 22. The at least one waveguide layer 21 and the at least one grating layer 22 are alternately stacked. When the waveguide structure 2 includes one waveguide layer 21 and one grating layer 22, the grating layer 22 is located on one side of the waveguide layer 21. When the waveguide structure 2 includes a plurality of waveguide layers 21 and a plurality of grating layers 22, the number of waveguide layers 21 is the same as the number of grating layers 22, and the plurality of waveguide layers 21 and the plurality of grating layers 22 are alternately stacked, i.e., one grating layer 22 is disposed between any two adjacent waveguide layers 21, and one waveguide layer 21 is disposed between any two adjacent grating layers 22.

The material of the waveguide layer 21 is a high-refractive-index material, such as high-refractive-index glass or resin. A refractive index of the waveguide layer 21 may be between 1.5 and 2.1. The material of the grating layer 22 may include titanium oxide, silicon nitride, zirconium oxide, hafnium oxide, or the like.

For a waveguide structure of a one-dimensional architecture, as shown in FIG. 7 and FIG. 8, the grating layer 22 includes an in-coupling grating 221 and a turning and out-coupling grating 222. For a waveguide structure of a two-dimensional architecture, the grating layer includes an in-coupling grating and an out-coupling grating. The basic principle of the waveguide structure 2 is that the in-coupling grating 221 couples light from an external optical engine into the waveguide layer 21, where the light propagates forward within the waveguide layer 21 via total internal reflection, and is then coupled out via the turning and out-coupling grating 222 (or the out-coupling grating) after pupil expansion, so as to integrate external ambient light with virtual information before reaching human eyes, thereby achieving an augmented display effect.

The first cover plate 1 is located on at least one of the opposite sides of the waveguide structure 2. The opposite sides of the waveguide structure 2 are opposite sides in a stacking direction of the waveguide layer 21 and the grating layer 22, i.e., the side (the backlight side of the waveguide structure 2) of the grating layer 22 facing away from the waveguide layer 21 and the side (the light-incident/light-emitting side of the waveguide structure 2) of the waveguide layer 21 facing away from the grating layer 22. That is, the first cover plate 1 may be located on the side of the grating layer 22 facing away from the waveguide layer 21, on the side of the waveguide layer 21 facing away from the grating layer 22, or on both the side of the grating layer 22 facing away from the waveguide layer 21 and the side of the waveguide layer 21 facing away from the grating layer 22.

In some embodiments, the waveguide module further includes a gluing structure 3. The gluing structure 3 is located between the waveguide structure 2 and the second protective layer 12, i.e., the second protective layer 12 is laminated to the waveguide structure 2 via the gluing structure 3, so that the first cover plate 1 is laminated to the waveguide structure 2 via the gluing structure 3.

It should be noted that the gluing structure 3 is located at the edge of the waveguide structure 2, i.e., the gluing structure 3 is located on a side of the in-coupling grating 211 of the grating layer 33 facing away from the turning and out-coupling grating 222 (or out-coupling grating) and on a side of the turning and out-coupling grating 222 (or out-coupling grating) facing away from the in-coupling grating 221 to prevent the gluing structure 3 from affecting the light transmission in the waveguide structure 2.

The gluing structure 3 may be a frame adhesive, and the material of the gluing structure 3 may include OCA, OCR, etc. The thickness of the gluing structure 3 may be between 30 micrometers and 100 micrometers.

Due to the high density and high rigidity of the second protective layer 12, the adhesion strength between the second protective layer 12 and the gluing structure 3 is greater than the adhesion strength between the first protective layer 11 and the gluing structure 3, thereby reducing the risk of delamination of the first cover plate 1 when the waveguide module is subjected to a high-temperature shock.

In some embodiments, first cover plates 1 are located on the opposite sides of the waveguide structure 2, i.e., the waveguide module includes two first cover plates, namely, a first cover plate 1a and a first cover plate 1b. As shown in FIG. 7, the second protective layer 12 of the first cover plate 1a is laminated to one side (e.g., the side of the grating layer 22 facing away from the waveguide layer 21) of the waveguide structure 2 via the gluing structure 3a. The second protective layer 12 of the first cover plate 1b is laminated to the other side (e.g., the side of the waveguide layer 21 facing away from the grating layer 22) of the waveguide structure 2 via the gluing structure 3b.

In some embodiments, the first cover plate 1 is located on one side of the waveguide structure 2, the waveguide module further includes a second cover plate 4, and the second cover plate 4 is located on the side of the waveguide structure 2 facing away from the first cover plate 1. As shown in FIG. 8, the second protective layer 12 of the first cover plate 1 is laminated to one side (e.g., the side of the grating layer 22 facing away from the waveguide layer 21) of the waveguide structure 2 via the gluing structure 3a. The second cover plate 4 is laminated to the other side (e.g., the side of the waveguide layer 21 facing away from the grating layer 22) of the waveguide structure via the frame adhesive 3b.

The material of the second cover plate 4 may include at least one of resin, sapphire, or tempered glass. The thickness of the second cover plate 4 may be between 1 mm and 2 mm.

In some embodiments, the waveguide module further includes an edge-sealing structure 5, and the edge-sealing structure 5 is located on side surfaces of the waveguide structure 2 and the first cover plate 1. When the first cover plates 1 are located on the opposite sides of the waveguide structure 2, as shown in FIG. 7, the edge-sealing structure 5 is located on the side surfaces of the first cover plate 1a, the waveguide structure 2 and the first cover plate 1b.

When the first cover plate 1 and the second cover plate 4 are located on the opposite sides of the waveguide structure 2, the edge-sealing structure 5 is also located on the side surface of the second cover plate 4. As shown in FIG. 8, the edge-sealing structure 5 is located on the side surfaces of the first cover plate 1, the waveguide structure 2 and the second cover plate 4.

The edge-sealing structure 5 is configured to absorb light. The material of the edge-sealing structure 5 may include ink, UV resin, etc. The thickness of the edge-sealing structure 5 may be between 0.3 mm and 2 mm.

The first cover plate 1 in the embodiments of the present application includes a first protective layer 11 and a second protective layer 12. The first protective layer 11 has a relatively low density and a relatively thin thickness to reduce the weight and thickness of the first cover plate 1. The second protective layer 12 has a relatively high rigidity to increase the rigidity of the first cover plate 1. The configuration of the ultra-thin second protective layer 12 does not significantly affect the weight and thickness of the first cover plate 1. As a result, the rigidity of the first cover plate 1 is increased while the weight and thickness of the waveguide module are reduced, thereby reducing the risk of deformation of the waveguide module when subjected to an external force and the risk of delamination of the cover plate when the waveguide module is subjected to a high-temperature shock, and ultimately enhancing the reliability of the waveguide module.

Accordingly, the embodiments of the present application also provide a display device including the waveguide module in the above embodiments, which will not be described in detail herein.

In the display device according to the embodiments of the present application, the thinner second protective layer 12 is disposed on one side of the first protective layer 11 with a lower density, thereby reducing the weight and thickness of the cover plate and consequently reducing the weight and thickness of the waveguide module. Moreover, since the rigidity of the second protective layer 12 is greater than the rigidity of the first protective layer 11, the rigidity of the cover plate is increased, reducing the risk of deformation of the waveguide module when subjected to an external force and the risk of delamination of the cover plate when the waveguide module is subjected to a high-temperature shock, thus enhancing the reliability of the waveguide module and further improving the reliability of the display device.

The display device according to the embodiments of the present application may be an AR display device, a product or component having an AR display function, such as AR glasses or an AR helmet.

In the specification and claims of the present application, the terms “first”, “second”, and so on are intended to distinguish between similar objects but do not necessarily indicate a specific order or sequence. It should be understood that the data used in this way may be interchanged where appropriate, so that the embodiments of the present application can be implemented in an order other than those illustrated or described herein, and that the objects distinguished by “first,” “second,” etc. are generally of one class. The number of objects is not limited, for example, the first object may be one or more.

In the description of the present application, the meaning of “a plurality of” is two or more.

In the description of this specification, descriptions with reference to the terms such as “an embodiment”, “some embodiments”, “illustrative embodiments”, “example”, “specific example”, or “some examples” mean that specific features, structures, materials, or characteristics described with reference to the embodiments or examples are included in at least one embodiment or example of the present application. In this specification, the illustrative expressions of the above terms do not necessarily refer to the same embodiment or example. Moreover, the specific features, structures, materials or characteristics described can be combined in any one or more embodiments or examples in any suitable manner.

Although the embodiments of the present application have been shown and described, those of ordinary skill in the art can understand that various changes, modifications, substitutions, and variations can be made to these embodiments without departing from the principles and spirit of the present application. The scope of the present application is defined by the claims and equivalents thereof.

1. A waveguide module, comprising:
a waveguide structure; and
a first cover plate located on at least one of opposite sides of the waveguide structure, wherein the first cover plate comprises a first protective layer and a second protective layer located between the first protective layer and the waveguide structure; and a rigidity of the second protective layer is greater than a rigidity of the first protective layer.

2. The waveguide module according to claim 1, wherein a density of the second protective layer is greater than a density of the first protective layer, and a thickness of the second protective layer is less than a thickness of the first protective layer.

3. The waveguide module according to claim 1, wherein the first cover plate further comprises an adhesive layer; and
the adhesive layer is located between the first protective layer and the second protective layer.

4. The waveguide module according to claim 1, wherein the first protective layer comprises a resin layer, and the second protective layer comprises an ultra-thin glass layer.

5. The waveguide module according to claim 1, wherein the thickness of the first protective layer is between 0.3 mm and 1 mm, and the thickness of the second protective layer is between 0.05 mm and 0.3 mm.

6. The waveguide module according to claim 1, further comprising a gluing structure,
wherein the gluing structure is located between the waveguide structure and the second protective layer.

7. The waveguide module according to claim 1, wherein the first cover plate is located on one side of the waveguide structure, and the waveguide module further comprises a second cover plate; and
the second cover plate is located on a side of the waveguide structure facing away from the first cover plate.

8. The waveguide module according to claim 7, wherein a material of the second cover plate comprises at least one of resin, sapphire, or tempered glass.

9. The waveguide module according to claim 1, wherein the waveguide structure comprises at least one waveguide layer and at least one grating layer;
the at least one waveguide layer and the at least one grating layer are alternately stacked; and the opposite sides of the waveguide structure are opposite sides in a stacking direction of the waveguide layer and the grating layer.

10. The waveguide module according to claim 1, further comprising an edge-sealing structure,
wherein the edge-sealing structure is located on side surfaces of the waveguide structure and the first cover plate.

11. A display device, comprising a waveguide module, wherein the waveguide module comprises:
a waveguide structure; and
a first cover plate located on at least one of opposite sides of the waveguide structure,
wherein the first cover plate comprises a first protective layer and a second protective layer located between the first protective layer and the waveguide structure; and a rigidity of the second protective layer is greater than a rigidity of the first protective layer.

12. A method for manufacturing a waveguide module, the method comprising:
forming a first cover plate, wherein the first cover plate comprises a first protective layer and a second protective layer located on one side of the first protective layer; and a rigidity of the second protective layer is greater than a rigidity of the first protective layer;
forming a waveguide structure; and
laminating the first cover plate to at least one of opposite sides of the waveguide structure, wherein the second protective layer is located between the first protective layer and the waveguide structure.

13. The display device according to claim 11, wherein a density of the second protective layer is greater than a density of the first protective layer, and a thickness of the second protective layer is less than a thickness of the first protective layer.

14. The display device according to claim 11, wherein the first cover plate further comprises an adhesive layer; and
the adhesive layer is located between the first protective layer and the second protective layer.

15. The display device according to claim 11, wherein the first protective layer comprises a resin layer, and the second protective layer comprises an ultra-thin glass layer.

16. The display device according to claim 11, wherein the thickness of the first protective layer is between 0.3 mm and 1 mm, and the thickness of the second protective layer is between 0.05 mm and 0.3 mm.

17. The display device according to claim 11, wherein the waveguide module further comprises a gluing structure,
wherein the gluing structure is located between the waveguide structure and the second protective layer.

18. The display device according to claim 11, wherein the first cover plate is located on one side of the waveguide structure, and the waveguide module further comprises a second cover plate; and
the second cover plate is located on a side of the waveguide structure facing away from the first cover plate.

19. The display device according to claim 18, wherein a material of the second cover plate comprises at least one of resin, sapphire, or tempered glass.

20. The display device according to claim 11, wherein the waveguide structure comprises at least one waveguide layer and at least one grating layer;
the at least one waveguide layer and the at least one grating layer are alternately stacked; and the opposite sides of the waveguide structure are opposite sides in a stacking direction of the waveguide layer and the grating layer.
